(19) United States
(12) Patent Application Publication
(10) Pub. No.: US 2014/0196094 A1
(43) Pub. Date: Jul. 10, 2014

(54) METHOD AND APPARATUS FOR AUTOMATICALLY SWITCHING CHANNELS

(71) Applicant: Samsung Electronics Co., Ltd., Suwon-si (KR)

(72) Inventors: Prasiddha Narayan SINGH, Noida (IN); Aditi GARG, Noida (IN); Prithveesh GOEL, Noida (IN)

(73) Assignee: Samsung Electronics Co., Ltd., Suwon-si (KR)

(21) Appl. No.: 14/147,989

(22) Filed: Jan. 6, 2014

(30) Foreign Application Priority Data
Jan. 7, 2013 (IN) 58/CHE/2013
Nov. 6, 2013 (KR) 10-2013-0134375

(51) Int. Cl. H04N 21/482

(52) U.S. Cl. CPC H04N 21/482
USPC 725/56

(57) ABSTRACT

A method and apparatus for automatically switching channels are provided. The method includes detecting an advertisement from content of a current channel that is displayed on a screen of a display apparatus; scanning at least one channel of a predetermined channel list to detect an advertisement-free channel, in response to the advertisement being detected on the current channel; and switching the current channel to the detected advertisement-free channel.

### RELATED APPLICATIONS

This application claims priority from Korean Patent Application No. 10-2013-0134375, filed on Nov. 6, 2013, and Indian Patent Application No. P58/CHE/2013, filed on Jan. 7, 2013, in the Indian Intellectual Property Office, the disclosures of which are incorporated herein by reference in their entirety.

### BACKGROUND

1. Field

Methods and apparatuses consistent with exemplary embodiments relate to a display apparatus, and more particularly, to the automatic switching of channels based on user preference during the display of advertisements.

2. Description of the Related Art

Display apparatuses are widely used for watching content. Examples of the display apparatuses include, but are not limited to, televisions (TVs), mobile devices, and computers.

While a user is watching content of a preferred channel, the user may be targeted with advertisements during periods when the content is not being displayed. However, if the user is not interested in the advertisements, the user may have to manually switch the display to other channels, which may be inconvenient.

### SUMMARY

One or more exemplary embodiments provide a method of automatically switching channels based on at least one user preference during the display of advertisements.

According to an aspect of an exemplary embodiment, there is provided a method of automatically switching channels, the method includes detecting an advertisement from content of a current channel that is displayed on a screen of a display apparatus; scanning at least one channel of a predetermined channel list to detect an advertisement-free channel, in response to the advertisement being detected on the current channel; and switching the current channel to the detected advertisement-free channel.

The method may further include maintaining the current channel when the advertisement is not detected.

The method may further include displaying a channel list selection menu for selecting the at least one channel of the predetermined channel list.

The predetermined channel list may be one of default channel lists that are based on genres and a user-defined channel list.

The user-defined channel list may include at least one channel that is selected by a user.

The at least one channel that is selected by the user may be displayed in at least one view.

The method may further include editing a channel list including the at least one channel that is selected by the user.

The editing of the channel list may include adding a channel to the channel list; deleting a channel from the channel list; and deleting the channel list.

The scanning may include scanning the at least one channel of the predetermined channel list on a second window, during display of the content of the current channel on a first window.

The second window may open when the advertisement is detected on the current channel, but may close when the advertisement-free channel is detected during channel scanning.

The at least one channel of the channel list may be sequentially scanned based on user customization.

The at least one channel of the channel list may be randomly scanned based on user customization.

In the switching of the current channel to the advertisement-free channel, content of the detected advertisement-free channel may be rendered on a first window on which the current channel is displayed; and a second window, on which the advertisement-free channel is scanned, may be closed.

According to an aspect of another exemplary embodiment, there is provided an apparatus for automatically switching channels, the apparatus including a channel list manager configured to store a channel list; a user interface (UI) controller configured to display the stored channel list; and a channel switching processor configured to, in response to detection of an advertisement on a current channel, scan at least one channel on the channel list to detect an advertisement-free channel, and then switch the current channel to the advertisement-free channel.

The apparatus may further include a deactivator configured to deactivate the channel switching processor.

The deactivator may perform one of a temporary deactivation and a permanent deactivation.

The channel switching processor may include an advertisement detector configured to detect the advertisement from content of the current channel; and a channel switching controller configured to, when the advertisement is detected on the selected channel, scan at least one channel in a predetermined channel list to detect the advertisement-free channel, and then switch the current channel to the advertisement-free channel.

According to an aspect of another exemplary embodiment, there is provided a display apparatus including a display configured to display content of a current channel and a channel list; and a channel switching controller configured to, in response to an advertisement being detected on the content of the current channel, scan at least one channel in the channel list to detect an advertisement-free channel, and then switch the current channel to the advertisement-free channel.

The channel switching controller may include a channel list storage configured to store the channel list; a user interface (UI) controller configured to display the channel list; and a channel switching processor configured to, when the advertisement is detected on a selected channel, scan the at least one channel on the channel list to detect the advertisement-free channel, and then switch the current channel to the advertisement-free channel.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a view of various environments for an internet protocol TV (IPTV) according to an exemplary embodiment;

FIG. 2 is a detailed block diagram of a display apparatus according to an exemplary embodiment;

FIG. 3 is a detailed block diagram of a channel switching controller of FIG. 2;

FIG. 4 is a detailed block diagram of a channel switching processor of FIG. 3;

FIG. 5 is a schematic flowchart of a method of automatically switching channels by using a display apparatus, according to an exemplary embodiment;

FIG. 6 is a detailed flowchart of a method of automatically switching channels by using a display apparatus, according to an exemplary embodiment;

FIG. 7 is a detailed flowchart of a method of generating a channel list for automatic switching of channels of FIG. 6;

FIG. 8 is a view of an exemplary embodiment of advertisement detection of FIG. 6;

FIG. 9A is a grid view of channels during generation of a user-defined channel list, according to an exemplary embodiment;

FIG. 9B is a view of a user interface (UI) during selection of a channel list, according to an exemplary embodiment; and

FIG. 9C is a view of a display apparatus scanning to detect an advertisement-free channel, according to an exemplary embodiment.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that although the terms “first”, “second”, etc. may be used herein to describe various components, these components should not be limited by these terms. These components are only used to distinguish one component from another.

The terms used in the exemplary embodiments are selected to describe exemplary embodiments, and are not used to limit the spirit and scope of the exemplary embodiments. The terms in the exemplary embodiments are selected as general terms used currently as widely as possible regarding functions of elements in the exemplary embodiments. However, in specific cases, terms arbitrarily selected by the applicant are also used, and in such cases, the meanings are mentioned in the corresponding detailed description section, so the exemplary embodiments should be understood not by literal meanings of the terms but by given meanings of the terms.

As used herein, the singular forms “a,” “an” and “the” are intended to include the plural forms as well, unless the context clearly indicates otherwise. It will be further understood that the terms “comprises” and/or “comprising” used herein specify the presence of stated features, numbers, processes, operations, components, elements, or a combination thereof, but do not preclude the presence or addition of one or more other features, numbers, processes, operations, components, elements, or a combination thereof.

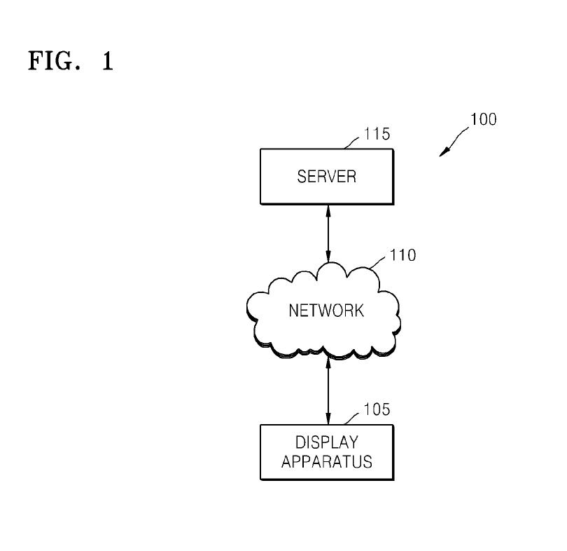

FIG. 1 is a view of an environment 100 for an internet protocol TV (IPTV) according to an exemplary embodiment.

The environment 100 includes at least one display apparatus, such as a display apparatus 105, a network 110, and a server 115. The display apparatus 105 is connected to the server 115 via the network 110. Examples of the display apparatus 105 include, but are not limited to, a digital TV, a smartphone, a mobile device, a tablet, a laptop, a personal digital assistant (PDA), and a home theater system. Examples of the network 110 includes, but are not limited to, a local area network (LAN), a wide area network (WAN), and a wireless network.

The display apparatus 105 is controlled by a user. The user may select a channel list by invoking a channel list selection menu. The display apparatus 105 activates advertisement detection, and when an advertisement is detected, the display apparatus 105 scans channels of the channel list that is selected by the user, and detects at least one advertisement-free channel. Then, the display apparatus 105 switches a current channel to an advertisement-free channel.

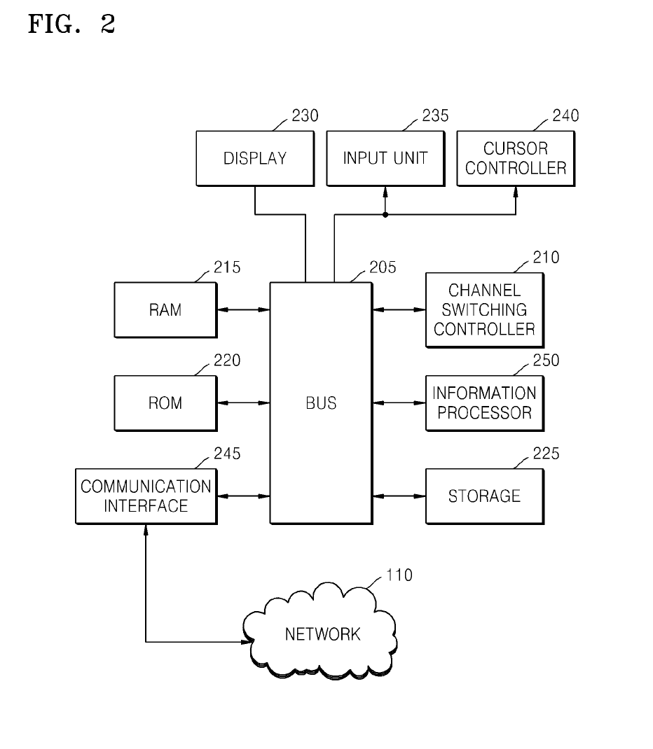

The display apparatus 105 includes a plurality of elements that are described in detail with respect to FIG. 2.

FIG. 2 is a detailed block diagram of the display apparatus 105 according to an exemplary embodiment.

The display apparatus 105 includes other communication systems for communication on a bus 205 for transmitting information, and an information processor 250 that is coupled to the bus 205. The display apparatus 105 includes a random access memory (RAM) 215 or other dynamic storage devices, in which commands to be executed by the information processor 250 are stored. The RAM 215 stores temporary variables and other intermediate information during execution of the commands by the information processor 250. The display apparatus 105 further includes a read only memory (ROM) 220 or other static storage devices, which are coupled to the bus 205 and stores static information.

The display apparatus 105 includes a storage 225 that is coupled to the bus 205, for example, a magnetic disk or an optical disk.

The display apparatus 105 includes a display 230 that is coupled to the bus 205. The display may be, for example, a liquid crystal display (LCD) or a cathode ray tube (CRT) display, but is not limited thereto. The display 230 displays content of the current channel and channel lists. The display apparatus 105 includes an input unit 235 and a cursor controller 240, which function as user input devices. The input unit 235 may include a plurality of number keys and function keys, and transmits information and command selections to the information processor 250 via the bus 205. The cursor controller 240 transmits direction information and command selections to the information processor 250 by using a mouse, a trackball, or cursor direction keys, and controls cursor movement on the display 230. The above-noted elements of the display apparatus may take the form of an entirely hardware embodiment such as a processor or circuit(s), an entirely software embodiment (including firmware, resident software, micro-code, etc.) or an embodiment combining software and hardware.

The display apparatus 105 may use the information processor 250 to implement various information processes.

In some exemplary embodiments, the information processor 250 executes the commands stored in the RAM 215. The commands may be read into the RAM 215 from another computer-readable medium, such as the storage 225.

The term “computer-readable medium” refers to any medium that participates in providing data that causes a computer to perform a certain function. According to an exemplary embodiment that is implemented by using the display apparatus 105, various computer-readable media are involved, for example, in providing commands to the information processor 250 for execution. The computer-readable medium may be a storage medium, either volatile or non-volatile. A volatile medium includes, for example, a dynamic memory device, such as the RAM 215. A non-volatile medium includes, for example, an optical or magnetic disk, such as the storage 225. All such media must be tangible to enable the commands executed by the media to be detected by a physical mechanism that reads the commands into a computer.

Common forms of computer-readable media include, for example, floppy disks, hard disks, magnetic tapes, or any other magnetic media; CD-ROMs, any other optical media, punch cards, paper tapes, any other physical media with patterns of holes, RAM, programmable read-only memories (PROMs), electrically programmable read-only memories (EPROMs), FLASH-EPROMs, or any other memory chips or cartridges.

In another exemplary embodiment, the computer-readable media may be transmission media including coaxial cables, copper wires, optical fibers, and wires that include the bus 205.

The transmission media may also have the form of acoustic or light waves, such as those generated during radio wave and infrared data communication. Examples of the computer-readable media include, but are not limited to, any media from which the display apparatus 105 may read. For example, the commands may initially be executed on a magnetic disc of a remote computer. The remote computer may load the commands into a dynamic memory, and transmit the commands over a telephone line via a modem. The modem may receive the data on the telephone line, and use an infrared transmitter to convert the data to infrared signals. An infrared detector may receive data transmitted by the infrared signals. The bus 205 transmits the commands and the data to the RAM 215. The information processor 250 receives and executes the commands from the bus 205. The commands may be selectively stored in the storage 225 either before or after execution by the information processor 250. All such media must be tangible to enable the commands executed by the media to be detected by a physical mechanism that reads the commands into a computer.

The display apparatus 105 includes a communication interface 245 that is coupled to the bus 205. The communication interface 245 provides two-way data communication by connecting the display apparatus 105 and the server 115, via the network 110. For example, the communication interface 245 may be a modem or an integrated services digital network (ISDN) card for providing data communication connection to a corresponding type of telephone line. As another example, the communication interface 245 may be a LAN card for providing data communication connection to a compatible LAN. In such implementation, the communication interface 245 transmits and receives electrical, electronic, or optical signals that transfer a digital data stream representing various types of information.

The display apparatus 105 includes a channel switching controller 210. In some exemplary embodiments, the channel switching controller 210 automatically activates a channel auto-switching mode. In other exemplary embodiments, the channel auto-switching mode is manually activated by the user.

In some exemplary embodiments, the channel auto-switching mode is automatically activated as the display apparatus 105 boots up. The channel auto-switching mode is activated by the user of the display apparatus 105. The user may select the channel list by invoking the channel list selection menu. The channel switching controller 210 activates the advertisement detection, and when the advertisement is detected. The channel switching controller 210 scans the channels of the channel list selected by the user, and detects at least one advertisement-free channel. Then, the channel switching controller 210 switches the current channel to the advertisement-free channel.

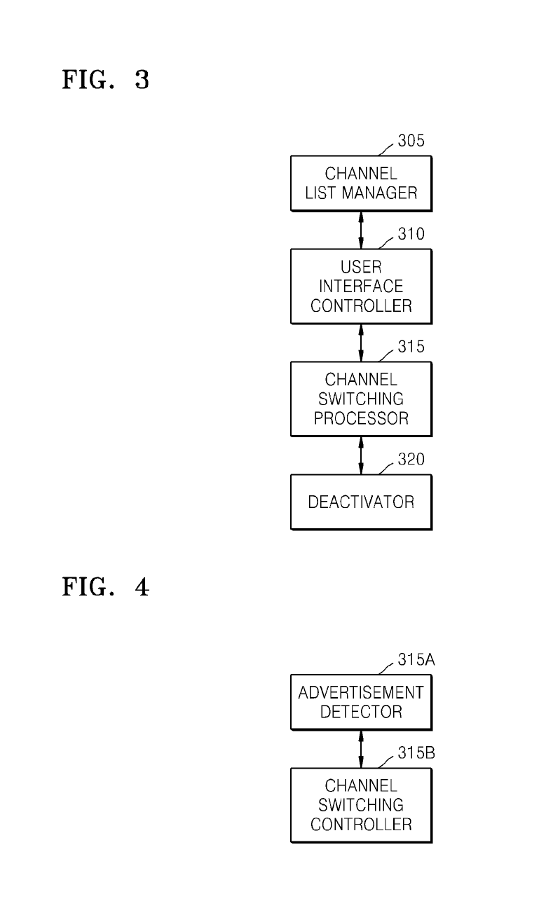

FIG. 3 is a detailed block diagram of the channel switching controller 210 of FIG. 2.

The channel switching controller 210 includes a channel list manager 305, a user interface (UI) controller 310, a channel switching processor 315, and a deactivator 320.

The channel list manager 305 is a first sub-system that is invoked when the channel auto-switching mode is activated. The channel list manager 305 stores and manages the channel lists. The channel list manager 305 generates and maintains default channel lists and user-defined channel lists. The channel list manager 305 generates the default channel lists based on genres. The default channel lists are maintained for a predetermined session, and are deleted when the predetermined session is finished. A user-defined channel list may be generated either from existing channel lists, or the user may generate the user-defined channel list from all channels. The user may directly perform operations, such as editing or deleting, only on the user-defined channel lists.

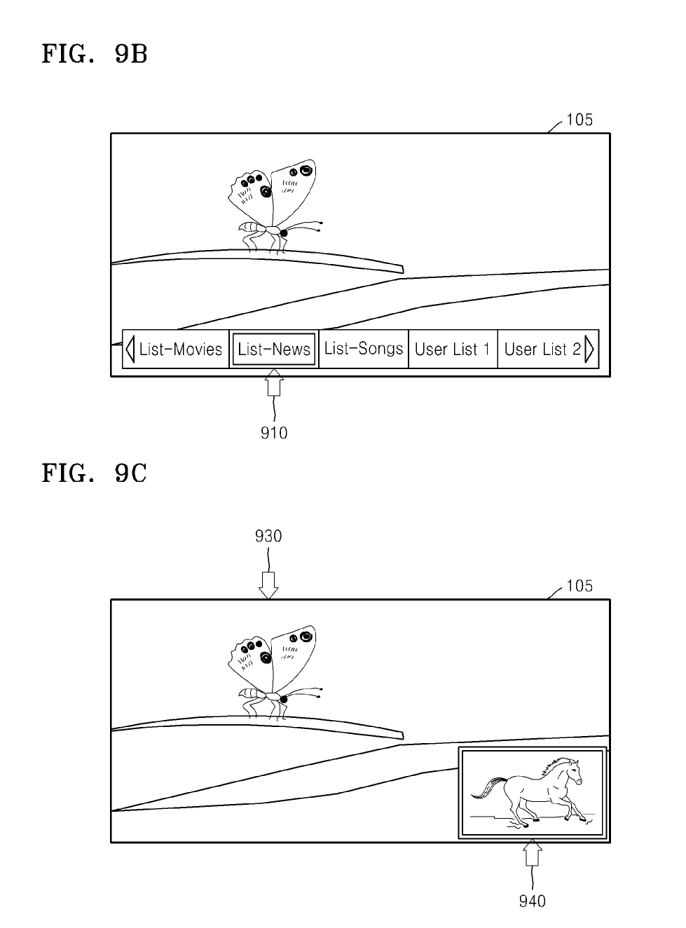

During generation of the channel list, the channel list manager 305 receives a name of the channel list from the user, and then lists the channels in various forms, such as a grid form as illustrated in FIG. 9A, which may be browsed by the user to select and add channels in the channel list. However, the arrangement of the channels is not limited thereto. The channel list manager 305 may store the channel list in any one of the network 110, for example, a network used for IPTVs; the display apparatus 105 itself; or on any external device. The channel list manager 305 stores information regarding preferred and alternate channels. The information is updated when the user edits the channels. As exemplarily illustrated in FIG. 9B, the channel list manager 305 provides all the channel lists to the UI controller 310 such that the user may select the channel list and scan for an alternate channel. Also, the channel list manager 305 activates the channel switching processor 315.

The UI controller 310 generates various UIs to receive user inputs. When the UI controller 310 is invoked by the channel list manager 305, the UI controller 310 obtains various channel lists from the channel list manager 305. The UI controller 310 displays the channel lists to the user for selection. Next, the selected channel list is transmitted to the channel switching processor 315. The UI controller 310 is invoked by the channel switching processor 315 during channel scanning. Next, the UI controller 310 simultaneously displays the current channel and a channel being scanned. For example, the UI controller 310 manages a picture in picture (PIP) window that is generated on the display apparatus 105 to display content of a scanned channel. During the scanning, the UI controller 310 renders the content of the current channel on a main window, and renders contents of the channel being scanned on the PIP window (refer to FIG. 9C). Next, when the advertisement-free channel is detected, the UI controller 310 closes the PIP window, and renders the advertisement-free channel into a full screen mode instead of the current channel.

The channel switching processor 315 is activated by the channel list manager 305. The channel switching processor 315 obtains the channel list from the UI controller 310. When an advertisement is detected from the content of the current channel, the channel switching processor 315 scans at least one channel in the channel list, and detects an advertisement-free channel. The channel switching processor 315 then switches the current channel to the advertisement-free channel.

FIG. 4 is a detailed block diagram of the channel switching processor 315 of FIG. 3.

The channel switching processor 315 includes an advertisement detector 315A and a channel switching controller 315B.

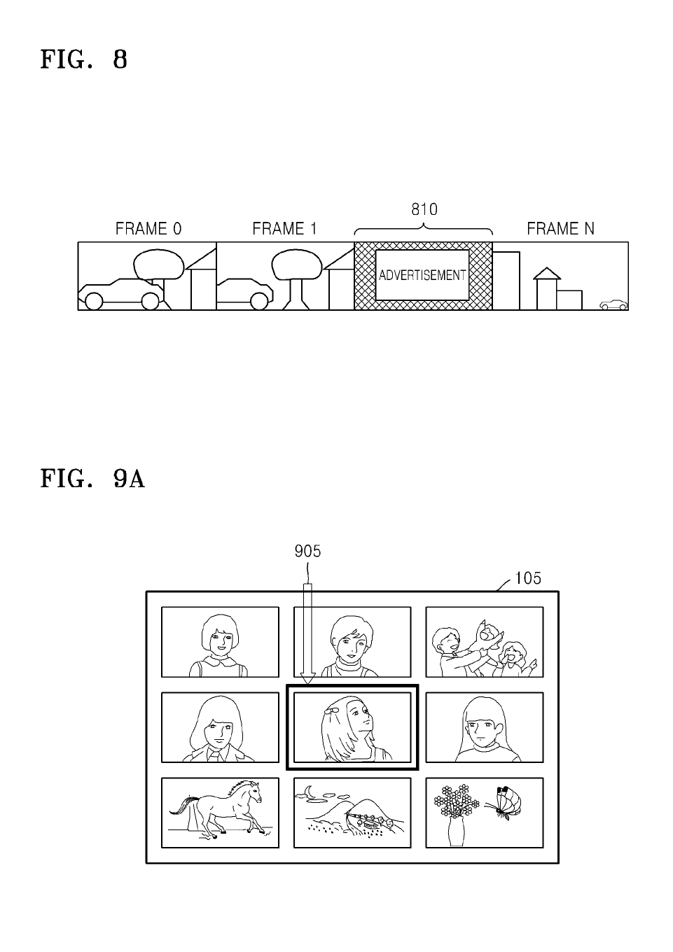

The advertisement detector 315A is activated by the channel list manager 305. Upon activation of the advertisement detector 315A, the current channel needs to be polled continuously to detect the advertisement. The advertisement detector 315A activates the channel switching controller 315B and the UI controller 310. The advertisement detector 315A detects the advertisement for the current and alternate channels. FIG. 8 illustrates the advertisement detection according to an exemplary embodiment. Referring to FIG. 8, the advertisement detector 315A detects an advertisement frame from among a plurality of frames.

There are various methods of detecting an advertisement in content. For example, the advertisement detector 315A may detect an advertisement based on image patterns of the current channel. As another example, the advertisement detector 315A may detect an advertisement from a moving-picture by using a black frame. As another example, the advertisement detector 315A may detect the advertisement based on black frames that appear due to fade-in and fade-out effects.

The channel switching controller 315B obtains a selection channel list from the UI controller 310. When the channel switching controller 315B is activated by the advertisement detector 315A, the channel switching controller 315B sequentially or randomly scans the channels of the channel list. During the scanning, when the advertisement-free channel is detected, the channel switching controller 315B outputs a switching control signal to the UI controller 310. In this case, the UI controller 310 renders content of the advertisement-free channel that is detected on the main window, and closes the PIP window. When the channel list is traversed from a beginning of the list to an end of the list, the channel list is scanned once again from the beginning to the end. The preferred channel and a currently reproduced alternate channel are not included during the scanning. Also, the user may set an alternate channel as a preferred channel, and accordingly, the channel list of the channel list manager 305 is updated. When the advertisement is detected on the alternate channel, the same process is repeated as described above. To describe the process, 4 scenarios are provided.

For example, in the case that a viewer is watching channel 0 and an advertisement is detected on channel 0, the user may select a channel list which sequentially includes channel 1, channel 2, channel 3, and channel 4. Next, the channel switching controller 315B starts scanning from channels 1 to 4. The channel switching controller 315B will stop scanning once an advertisement-free channel displaying content is detected. There are various scenarios that may occur as follows:

Scenario 1: While the alternate channel is rendered, an advertisement ends on the channel 0. Then, the channel 0 is immediately restored.

Scenario 2: Content is not available on any channel in the channel list when channels 1 to 4 are scanned. Then, the scanning restarts from channel 1.

Scenario 3: During the scanning, content is received from channel 2, and after a period of time, an advertisement starts on channel 2. However, the advertisement has not yet ended on channel 0. Thus, scanning for a next advertisement-free channel continues from the channel 3. If the advertisement-free channel is not found, the scanning for the next advertisement-free channel loops back in the channel list.

Scenario 4: When the user wants to watch the alternate channel and does not want to switch back to channel 0, the user may temporarily or permanently deactivate the channel auto-switching mode.

Referring back to FIG. 3, the deactivator 320 temporarily or permanently deactivates the channel auto-switching mode. During a permanent deactivation, the deactivator 320 releases all resources that are obtained by the channel auto-switching mode. When the channel auto-switching mode is deactivated, a viewing is restored back to normal. A temporary deactivation is used when the user switches to the alternate channel or the advertisement-free channel while the advertisement is displayed on the preferred channel or the current channel, or when the user prefers contents of the alternate channel. The user does not want to switch back to the preferred channel for some time, even when the advertisement has ended on the preferred channel. During the temporary deactivation, a state of the preferred channel is continuously maintained. At any point of time, the viewer may return and activate the channel auto-switching mode on the preferred channel.

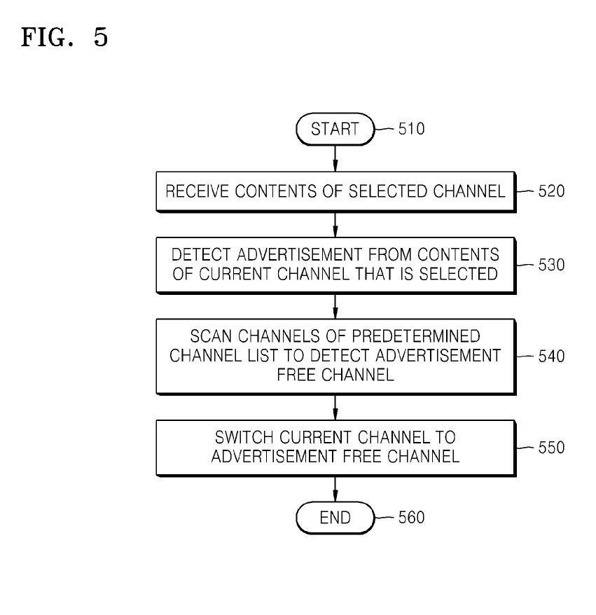

FIG. 5 is a schematic flowchart of a method of automatically switching the channels by using a display apparatus, according to an exemplary embodiment.

In operation 510, the method starts.

In operation 520, the display apparatus receives content of channels that are selected by the user.

In operation 530, the display apparatus detects an advertisement from content of a current channel that is selected.

In operation 540, the display apparatus scans channels of a predetermined channel list to detect an advertisement-free channel.

In operation 550, when the advertisement-free channel is detected based on a scanning result, the display apparatus switches the current channel to the advertisement-free channel that corresponds to an alternate channel.

In operation 560, the method ends.

According to an exemplary embodiment, the viewer may watch the preferred channel during the advertisement.

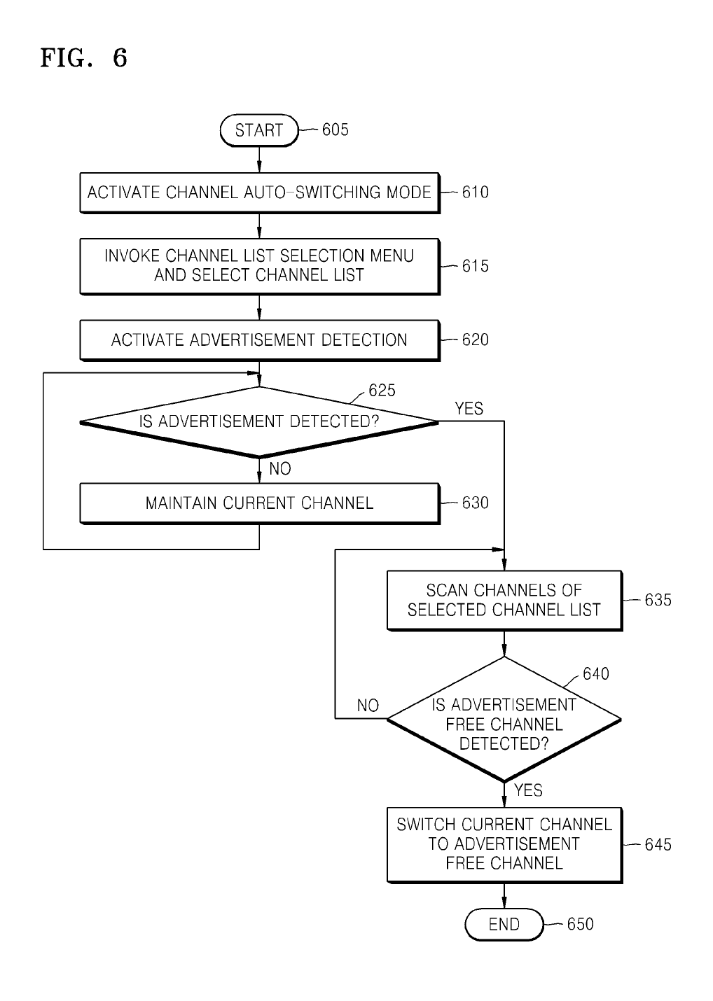

FIG. 6 is a detailed flowchart of a method of automatically switching channels by using a display apparatus, according to an exemplary embodiment.

In operation 605, the method starts.

In operation 610, the display apparatus activates the channel auto-switching mode through the user's selection.

In operation 615, the display apparatus invokes the channel list selection menu so that the user may select the channel list.

In operation 620, the display apparatus activates a channel detection mode to detect the advertisement from the content of the current channel that is selected.

In operation 625, the display apparatus determines whether the advertisement is detected while reproducing the content on the current selected channel.

In operation 630, if the advertisement is not detected on the current channel, the display apparatus maintains the current channel.

In operation 635, if the advertisement is detected in the content of the current channel, the display apparatus scans the channels of the channel list that is selected by the user. The channels of the channel list may be sequentially or randomly scanned based on user customization.

In operation 640, the display apparatus determines whether an advertisement-free channel is detected while scanning the channel list. If the advertisement-free channel is detected, operation 645 is performed; if not, operation 635 is performed.

In operation 645, when the advertisement-free channel is detected, the display apparatus switches the current channel to the advertisement-free channel. In some exemplary embodiments, the current channel is restored once the advertisement is finished.

In operation 650, the method ends.

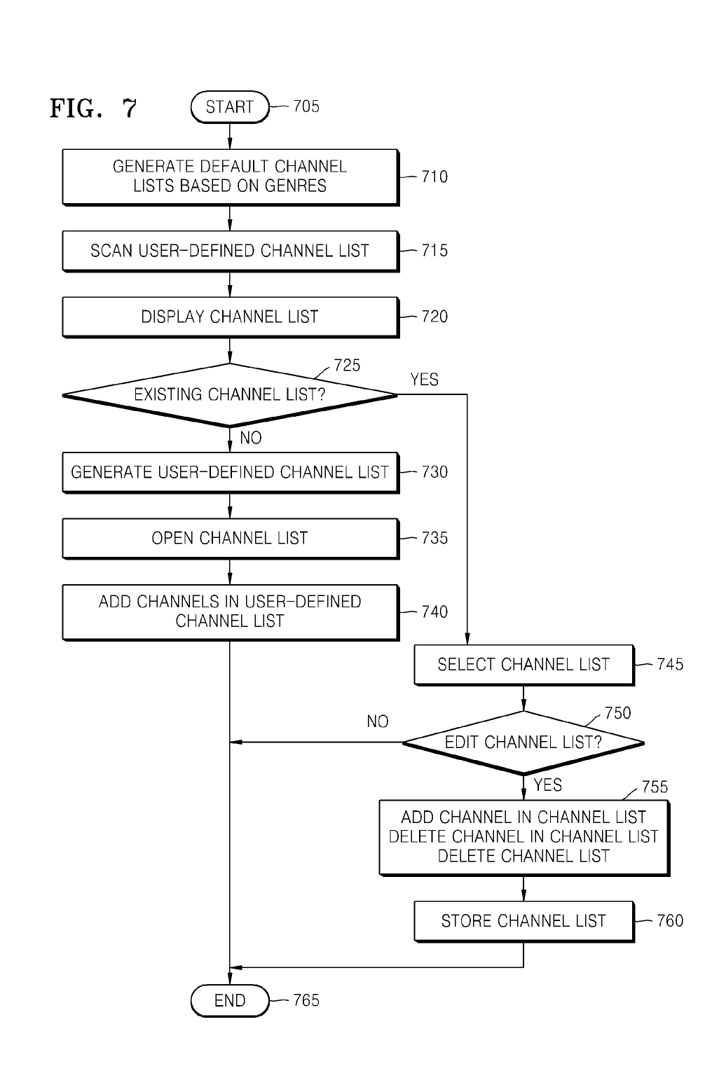

FIG. 7 is a detailed flowchart of a method of generating a channel list for the automatic switching of channels of FIG. 6.

In operation 705, the method starts.

In operation 710, the default channel lists are generated based on genres. The genres may include, but are not limited to, movies and songs.

In operation 715, the user-defined channel list is detected.

In operation 720, the channel list that is detected is displayed. In some exemplary embodiments, the channel list is detected from the display apparatus 105, the network 110, or an external storage device.

In operation 725, it is determined whether or not an existing channel list is to be used. If the existing channel list is not to be used, operation 730 is performed; or else, operation 745 is performed.

In operation 730, when the existing channel list is not to be used, the user-defined channel list is generated. The user-defined channel lists may be stored in the display apparatus 105, the network 110, or the external storage device.

In operation 735, the channel list is opened and displayed.

In operation 740, at least one channel is added to the user-defined channel lists.

In operation 745, when the existing channel list is to be used, the existing channel list is selected.

In operation 750, when the existing channel list is selected, it is determined whether or not the channel list is to be edited. If the channel list is edited, operation 755 is performed; if not, operation 765 is performed.

In operation 755, the channel list may be edited by adding a channel, by deleting a channel, or by deleting the channel list itself.

In operation 760, an edited channel list is stored.

In operation 765, the method ends.

According to an exemplary embodiment, the viewer may define channels to be viewed during advertisements.

FIG. 9A is a grid view of the channels during generation of a user defined channel list, according to an exemplary embodiment;

FIG. 9A is a grid view of channels during generation of the user-defined channel lists, according to an exemplary embodiment. The user generates the channel list by selecting a channel 905 from among channels displayed on the grid view.

FIG. 9B is a view of a UI during selection of a channel list, according to an exemplary embodiment. For example, a plurality of channel lists are displayed on the current channel. The user selects a channel list 910 named “List-News” from among the plurality of channel lists.

FIG. 9C is a view of the display apparatus 105 scanning to detect the advertisement-free channel, according to an exemplary embodiment.

During the scanning for the advertisement-free channel, a current channel and the advertisement-free channel are simultaneously displayed on the display apparatus 105, for example, the current channel may be displayed on a main window 930, and the advertisement-free channel may be displayed on a PIP window 940. The current channel is displayed on the main window 930 while the scanning for the advertisement-free channel is performed on the PIP window 940 at a bottom of a screen of the display apparatus 105. However, the location of the PIP window is not limited to the bottom of the screen. The PIP window 940 is invoked when the advertisement is detected on the current channel, and is closed when the advertisement-free channel is detected.

As described above, according to the one or more of the above exemplary embodiments, channels may be automatically switched during display of advertisements, based on user preferences. Therefore, a user may continuously watch content on an interested channel during display of the advertisement. The user may deactivate a channel auto-switching mode as desired. Also, according to the exemplary embodiments, the user may customize channels which the user wants to watch during display of the advertisement.

According to the exemplary embodiments, a method of automatically switching channels during display of advertisements based on user preferences can also be implemented through computer-readable code/instructions in/on a medium, e.g., a computer-readable medium, to control at least one processing element to implement any above-described exemplary embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, RAM, floppy disks, hard disks, magnetic tapes etc.) and optical recording media (e.g., CD-ROMs or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A method of automatically switching channels, the method comprising:
detecting an advertisement from content of a current channel that is displayed on a screen of a display apparatus;
scanning at least one channel of a predetermined channel list to detect an advertisement-free channel, in response to the advertisement being detected on the current channel; and
switching the current channel to the detected advertisement-free channel.

2. The method of claim 1, further comprising maintaining the current channel when the advertisement is not detected.

3. The method of claim 1, further comprising displaying a channel list selection menu for selecting the at least one channel of the predetermined channel list on the screen of the display apparatus.

4. The method of claim 1, wherein the predetermined channel list is one of default channel lists that are based on genres, and a user-defined channel list.

5. The method of claim 4, wherein the user-defined channel list includes at least one channel that is selected by a user.

6. The method of claim 5, the at least one channel that is selected by the user is displayed in at least one view.

7. The method of claim 5, further comprising editing a channel list comprising the at least one channel that is selected by the user.

8. The method of claim 7, wherein the editing the channel list comprises:
adding a channel to the channel list;
deleting a channel from the channel list; and
deleting the channel list.

9. The method of claim 1, wherein the detecting the scanning comprises scanning the at least one channel of the predetermined channel list in a second window on the screen of the display apparatus while the content of the current channel is displayed in a first window on the screen of the display apparatus.

10. The method of claim 9, wherein the second window is activated when the advertisement is detected in the current channel, the second window is deactivated when the advertisement-free channel is detected during the channel scanning.

11. The method of claim 1, wherein the scanning comprises sequentially scanning the at least one channel of the channel list based on user customization.

12. The method of claim 1, wherein the scanning comprises randomly scanning the at least one channel of the channel list based on user customization.

13. The method of claim 1, wherein in the switching the current channel to the advertisement-free channel, content of the detected advertisement-free channel is rendered in a first window on the screen of the display apparatus on which the current channel is displayed; and a second window on the screen of the display apparatus, on which the advertisement-free channel is scanned, is deactivated.

14. An apparatus for automatically switching channels, the apparatus comprising:
a channel list manager configured to store a channel list;
a user interface (UI) controller configured to display the stored channel list; and
a channel switching processor configured to, in response to detection of an advertisement on a current channel, scan at least one channel on the channel list to detect an advertisement-free channel, and then switch the current channel to the advertisement-free channel.

15. The apparatus of claim 14, further comprising a deactivator configured to deactivate the channel switching processor.

16. The apparatus of claim 15, wherein the deactivator is configured to perform one of a temporary deactivation and a permanent deactivation of the channel switching processor.

17. The apparatus of claim 14, wherein the channel switching processor comprises:
an advertisement detector configured to detect the advertisement from content of the current channel; and
a channel switching controller configured to, in response to detection of the advertisement on the current channel, scan at least one channel in a predetermined channel list to detect the advertisement-free channel, and then, switch the current channel to the advertisement-free channel.

18. A display apparatus comprising:
a display configured to display content of a current channel and a channel list; and
a channel switching controller configured to, in response to an advertisement being detected on the content of the current channel, scan at least one channel in the channel list to detect an advertisement-free channel, and then switch the current channel to the advertisement-free channel.

19. The display apparatus of claim 18, wherein the channel switching controller comprises:
a channel list storage which is configured to store the channel list;
a user interface (UI) controller configured to display the channel list; and
a channel switching processor configured to, in response to detection of the advertisement on a current channel, scan the at least one channel on the channel list to detect the advertisement-free channel, and then switch the current channel to the advertisement-free channel.

20. A non-transitory computer-readable recording medium having recorded thereon a program, which, when executed by a computer, performs the methods of claim 1.

21. A method of switching channels in a display apparatus, the method comprising:
receiving content of a selected channel, and displaying the received content in a first window on a screen of the display apparatus;
detecting an advertisement in the received content of the selected channel;
activating a second window on a screen of the display apparatus and displaying at least one channel list in the second window in response to an advertisement being detected in the received contents;
detecting an advertisement-free channel in the at least one channel list, and
switching from the selected channel to the advertisement-free channel.

22. The method of claim 21, wherein the second window is activated when the advertisement is detected, and is deactivated when the advertisement-free channel is detected.

23. The method of claim 21, wherein channels of the channel list are sequentially scanned or randomly scanned based on user customization.
